(19) United States
(12) Patent Application Publication
(10) Pub. No.: US 2008/0005321 A1
(43) Pub. Date: Jan. 3, 2008

(54) Monitoring and Managing Distributed Devices

(76) Inventors: Lin Ma, Beijing (CN); Xing Xing Li, Beijing (CN)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/762,093

(22) Filed: Jun. 13, 2007

(30) Foreign Application Priority Data
Jun. 29, 2006 (CN) 200610099793.2

(51) Int. Cl. G06F 15/173

(52) U.S. Cl. 709/224

(57) ABSTRACT

Distributed network devices are monitored and managed by a monitoring server. The monitored devices are divided into a plurality of groups, one of monitored devices in each group being appointed the primary device of the group. Group status information is normally received only from the primary device of the group or receiving member status information from a member device. When group status information is received by the monitoring server, the monitoring server may assign the devices covered by the group status report to new groups with the same or a different primary device.

### TECHNICAL FIELD

The present invention relates in general to device monitoring and more specifically to monitoring and managing distributed devices.

### BACKGROUND OF THE INVENTION

In systems for monitoring and managing distributed assets, the asset states are tracked by a monitoring server. For example, in asset management applications, large numbers of monitored devices report their status to the monitoring server so that the monitoring server can execute applications such as data analysis, asset management and maintenance. As another example, in RFID and RF card based solutions, the monitoring server collects RF card and label information transmitted by card readers. As still another example, in software upgrade applications, a client device sends a monitoring server information about its installed software, including program names and version numbers and sometimes including status information for subcomponents and patches. In some distributed monitoring and managing systems, a client provides status information to the monitoring server that may include the CPU usage status, memory usage status, the operating system being used and its version, the hard-disk usage status, active processes, battery status, power consumption, etc.

In a traditional asset management system, each client can independently control when it sends status information to the monitoring server. At times, the monitoring server will receive large numbers of client status reports over a short time, which can overload the monitoring server. At other times, the monitoring server will receive few client reports over a given time period, leaving the monitoring server idle and underutilized.

A possible solution to the problem noted above is to enable the monitoring server to poll all clients for status information on a fixed schedule controlled by the monitoring server. Because the monitoring server controls the polling schedule, the server workload can be balanced.

However, an ordinary polling solution has drawbacks. First, the requirement that each client be polled places on extra burden on the monitoring server. Second, if a client can report its status only when polled, an emergency at the client may go unreported for an unacceptably long time. For example, if a client is already running using power supplied by a battery backup system and the battery backup system begins to fail, the client may totally fail before it is polled again by the monitoring server. Third, in any polling solution, each monitoring server must maintain the address of each monitored client. If a client address changes, the monitoring server will be unable to find the client to obtain its status. Also, when a new client is added, the monitoring server must be provided an address for the new client if the monitoring server is to rearrange its polling schedule and poll the new client at the appropriate time.

Another known solution enables a monitoring server to obtain client status information in two ways. The monitoring server retains control over the polling of monitored clients for status information, deciding how often to poll each client. However, a monitored client may send an unsolicited status report to the monitoring server in specific predefined situations, for example, in emergencies. The workload of the monitoring server remains balanced to some extent. This solution can overcome the problem of undetected client emergencies but does not solve the problems of changing client addresses and clients being added to the monitored system

Another known solution is Remote Monitoring (RMON). Remote Monitoring is a standard monitoring specification for enabling all kinds of network monitors and consoles to exchange network monitoring data. In this technical solution, monitored devices are divided into groups, and each device in a group reports its status to a primary group device. The primary group device reports the status all members of the group to the monitoring server. An RMON monitoring server is typically added as a primary group device at a router or hub. For static groups, where the devices in each group are fixed, the primary group device can report status information of the group directly to the monitoring server. An RMON solution decreases traffic to the monitoring server, enables client emergencies to be reported on a more timely basis and achieves some workload balancing. However, if a primary group device fails, a monitoring server will receive no status information about any member of the group.

A new solution is needed which will allow (1) client status information to be obtained on a timely basis while retaining server load balancing, (2) monitored clients to report status information directly to a monitoring server even in an emergency situation, and (3) monitoring servers to reliably obtain status information for monitored devices.

### SUMMARY OF INVENTION

The invention may be implemented as a method for monitoring and managing distributed devices, wherein a monitoring server is used to monitor a plurality of monitored devices, and wherein the plurality of monitored devices are divided into a plurality of groups with one of monitored devices in each group being assigned the role of a primary device for the group. The method steps include receiving group status information from the primary device of a group or directly from a member device. When a group status report is received, the monitoring server may form new groups and appoint a different monitored device to the role of primary device for each new groups. Each primary device is notified of its new role and given information identifying members of its group.

### BRIEF DESCRIPTION OF THE DRAWINGS

The foregoing and features and advantages of the invention will be apparent from the following detailed description read in conjunction with the accompanying drawings wherein like reference numbers generally represent like parts of exemplary embodiments of the invention.

FIG. 1 illustrates operations occurring in a distributed monitoring system according to one embodiment of the present invention;

FIG. 2 illustrates operations performed by a group primary device according to one embodiment of the present invention;

FIG. 3 is a flow chart of operations in a monitored device according to one embodiment of the present invention;

FIG. 4 illustrates an initialization process for a monitored device according to one embodiment of the present invention;

FIG. 5 illustrates part of a preferred initialization process according to one embodiment of the present invention;

FIG. 6 illustrates the result of the preferred initialization process in a specific scenario according to one embodiment of the present invention;

FIG. 7 illustrates the working process of the monitoring server within a reporting cycle according to one embodiment of the present invention;

FIG. 8 is a flow chart of operations in a system for monitoring and managing distributed devices according to one embodiment of the present invention;

FIG. 9 illustrates a preferred functional structure for a group primary device according to one embodiment of the present invention; and

FIG. 10 illustrates a preferred functional structure of a monitored device according to one embodiment of the present invention.

### DETAILED DESCRIPTION

Preferred embodiments of the present invention will now be described more fully with reference to the accompanying drawings. This invention may, however, be embodied in different forms and should not be construed as limited to the embodiments set forth herein.

In a system in which a monitoring server monitors a plurality of monitored devices (clients), a client can report its status information to the monitoring server. In general, each client has a reporting cycle of predetermined length, for example, every 2 hours. Different clients may have different reporting cycles. When a client starts up, it begins tracking the time that has elapsed since startup. At the end of the reporting cycle, the client sends its current status information to the monitoring server and resets a reporting cycle counter. For example, assuming the reporting cycle of a client is 2 hours, if the client starts at 10:05, then it will report its status information to the monitoring server at 12:05 and reset its counter to zero to begin the next reporting cycle.

In accordance with the invention, clients are designated as falling into one of two categories; namely, primary devices and member devices. The designation is based on the role played by a client device at a given time, not on any structural differences between devices having different designation. When a new group is created, one client is designated as the group primary device and the identities of other members of the new group are made known to the primary device. The new primary device maintains status information for the group only for an indefinite time period, not necessarily permanently. When a primary device reports group status information to the monitoring server at the end of a reporting cycle, the existence of the group may be terminated by the monitoring server with members of the group, including the former primary device, being assigned to other groups. The collection of group status information and the definition of successor groups are performed in one interaction.

A member device may belong to a plurality of groups because it plays different roles in different groups. A member device knows its own reporting cycle and the address or addresses of each monitoring server to which it may need to report status information, but is not otherwise aware of which group or groups to which it belong.

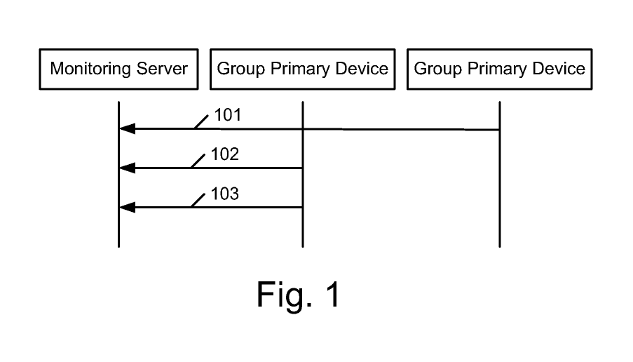

FIG. 1 briefly illustrates what can happen in a distributed monitoring system at the end of a reporting cycle according to one embodiment of the present invention. Here three roles are defined: a monitoring server, a group primary device and group member device. Although only one primary device and one member device are shown, those skilled in the art will understand that a typical system will include a plurality of groups with each group having a primary device and a plurality of member devices. As noted above, a client device can belong to more than one group at a given time.

In general, a group primary device obtains status information from members of its group during the reporting cycle. The reporting cycles for a group primary device and for members of the group may be different, but in general, the reporting cycle for the group primary device should before that of any of the other members of the group. The primary device obtains status information from each member of its group by a predetermined time before the primary device is expected to provide group status information to the primary server. In step 101, the primary device of the group has collected the group status information and sends it to monitoring server.

After the monitoring server receives and processes the group status information from a group's primary device, one of several things may happen. If the group status report indicates all group members are operating normally, the group may be preserved without changes. If the group status report indicates some members of the group are not operating normally, those members may be reassigned to other groups. If a monitoring server finds that status information has been reported directly by one or more members of the group, the monitoring server may dissolve the group and assign the member groups to other groups with different group primary devices.

Once each member device has been assigned to a group, whether it is a renewal of its last group or is a different group, the member device must restart its individual reporting cycle so that its individual reporting cycle does not end before the reporting cycle of its new group primary device.

In forming new groups, the monitoring server may take the reporting cycles of potential group members into account and create one or more groups in which the group members have reporting cycles similar to the reporting cycle of the group primary device

If a primary device fails to collect and report status information when expected, the failure may be a localized failure either in the primary device or in a network connection between the primary device and the monitoring server. Notwithstanding its membership in a group, each group member tracks its own reporting cycle. If a group member's reporting cycle ends (i.e., is not restarted as a result of a successful group status report from the group primary device), the group member collects its own status information in step 102 and sends it directly to the monitoring server.

After the member device reports its status information, in step 103, the monitoring server may assign all clients that have provided client status reports directly to new groups. The new groups can be created using different criteria. In one embodiment, the monitoring server may transfer a client to a group with similar reporting times, assigning one of the clients the role of group primary device. Alternatively, clients that have directly reported their own status information may be aggregated into a completely new group. Further, the monitoring server may assign the directly-reporting client to the next group from which it receives a group status report. As part of the processing of the group status information, the monitoring server will inform the group primary device that a new member has been added to the group. The methodologies for forming new groups or adding new members to existing groups are not limited to those described above. Other methodologies may occur to those skilled in the art and fall within the scope of the invention.

The prior discussion is limited to a situation where a group member device reaches the end of its reporting cycle. If the member device fails before the end of its reporting cycle or before the end of the group reporting cycle, a member device preferably can immediately notify the monitoring server of its failure.

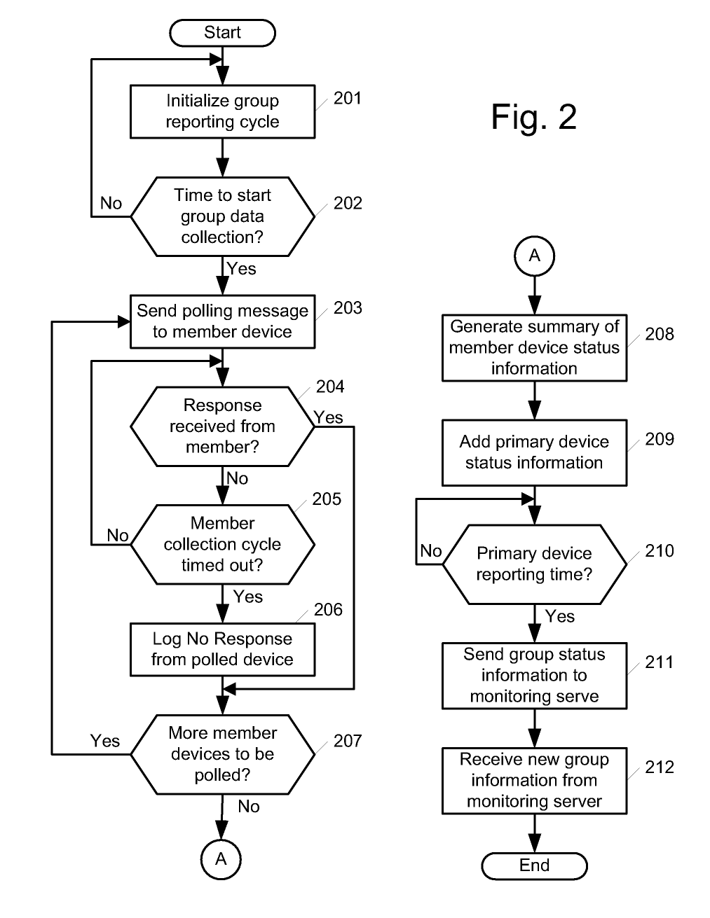

FIG. 2 illustrates operations performed by a group primary device during a normal reporting cycle according to one embodiment of the present invention. A client device begins operating as a primary device once he receives that assignment from a monitoring server. In step 201, the newly appointed primary device initializes its reporting cycle counter to zero to begin a new group reporting cycle. The primary device enters a wait loop 202 which ends only when the reporting cycle has progressed to the point at which the primary device needs to begin collecting status information from members of its group.

The time at which the primary device begins data collection could be a fixed time prior to the end of the primary device reporting cycle or vary from one primary device to the next as a function of the number of group members from whom status information is to be collected, the amount of status information to be collected and the time required to initiate and complete data collection from each member device.

Monitored device(s) may be members of multiple groups. It is possible that two different group primary devices may attempt to obtain status information from the same member device at almost the same time. If a member device has recently reported status information to one primary device, it may elect to ignore a request for status information subsequently received from the second primary device. Allowing a member to ignore a request for status information under these conditions will not significantly affect the performance of monitoring system since the monitoring server will still receive at least one timely status report for the client and will reduce unneeded status reports to one or more primary devices and to the monitoring server.

When data collection begins, the group primary device polls the first member device for status information in step 203 and checks for a response from the polled member in a step 204. Obviously, the first time step 204 is implemented, no response can have been provided and the program proceeds to step 205, in which it is determined whether the collection cycle for the polled member has timed out. The reason for setting a collection cycle for a polled member is in case the member device is incapable of responding due to a failure either at the polled member failure or in a network between the polled member and the primary device. The program enters a wait loop consisting of steps 204 and 205 which continues either until a status report is received from the polled member (step 204) or the member device data collection cycle has timed out (step 205).

If a status report is received from the polled member before the member data collection cycle times out, the program jumps from step 204 to step 207, in which a determination is made whether there are other member devices in the group that still need to be polled. If there are, the next member device is selected in step 203 and the data collection steps are repeated for the newly selected member device.

If a polled member's data collection cycle times out without a status report from a polled member, the primary device logs the lack of a response in step 206 and then checks (step 207) whether other member devices still need to be polled.

Once the primary device has polled all members of the group and has received either a status report or has logged the lack of a response for each member, the primary device begins a data summarization phase. In step 208, a summary of the member status information is generated. The primary device's own status information is then added in step 209 to complete the group's status report.

The group status report will include the identity of each monitored device and at least some of the following information for each device: the usage of the monitored device, the usage of memory, the device's operating system, the usage of hard disk, the active process, the battery status, power consumption, etc., The identification of the monitored device may take form of the IP address of the monitored device, MAC address or the identification provided by the application to monitored device or other forms that permit the monitoring server to uniquely identify each monitored. In addition, if the monitoring server has the capacity to create groups of monitored devices having similar reporting time, then the group status report preferably includes the next reporting time for each monitored device so as to facilitate the formation of such groups.

The primary device then checks in step 210 to determine whether it is time to send the group status report to the monitoring server and enters a wait loop until the group reporting time is reached. Delaying the group status report, even where it is ready before the group reporting time is reached, maintains workload balancing for the monitoring server. When the group reporting time, which is really the established reporting time for the primary device, arrives, the primary device forwards the group status information to the monitoring server in a step 211.

In step 212, the primary device receives new group information from the monitoring server, possibly including new group assignments for both the primary device and other members of the group. If the primary device or another member of the group is assigned the role of a primary device for the next reporting cycle, information returned from the monitoring server will include the identities of group members for each newly appointed (or re-appointed) primary device in the group.

The receipt of new group assignments at the group primary device and the distribution of this information to the group members ends the reporting cycle.

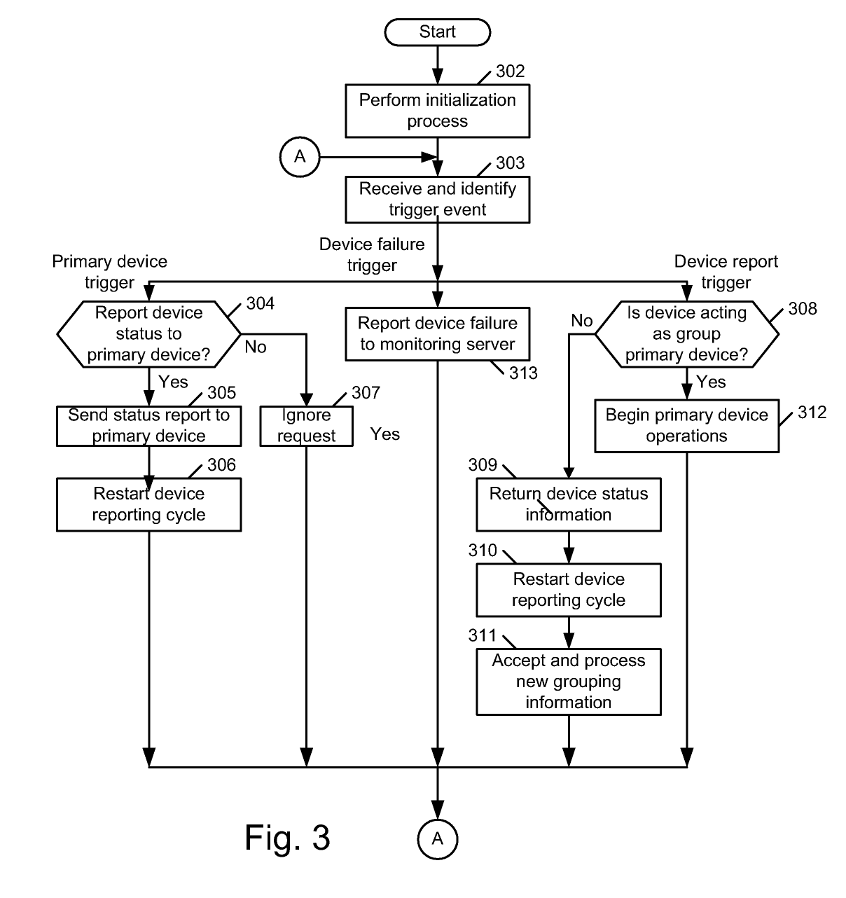

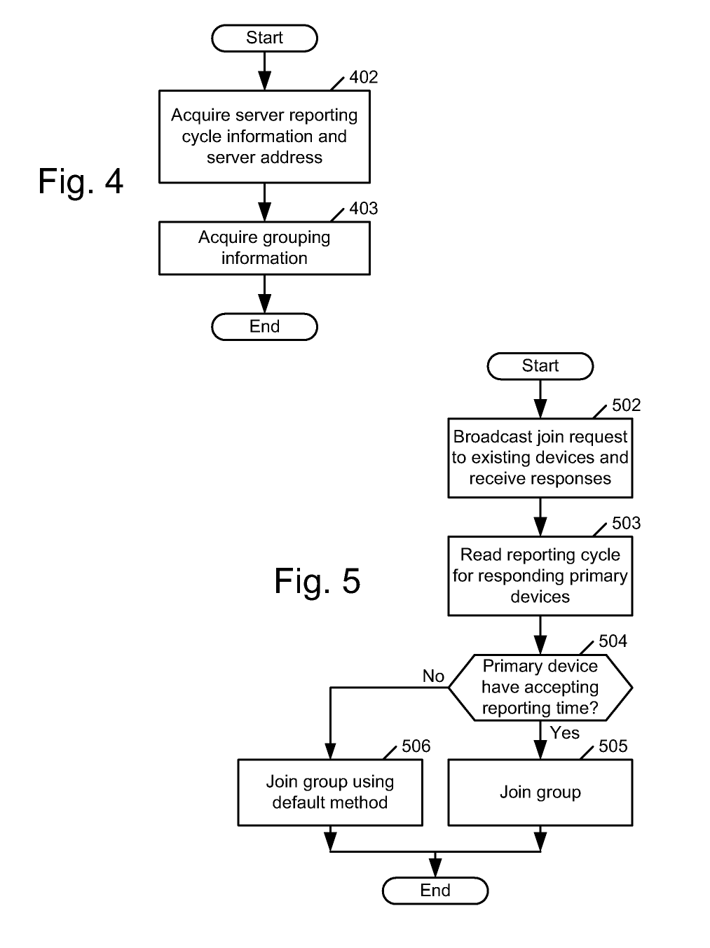

FIG. 3 illustrates operations performed in a primary device acting both in its role as the group primary device and in its role as a monitored device, according to one embodiment of the present invention. The device is initialized in step 302 at the beginning of each reporting cycle. As part of the initialization, the device obtains the address of the group primary device (if it isn't the primary device itself) and the group reporting time. The detailed initialization process will be described later with reference to FIG. 4. After initialization, the monitored device performs the tasks for which it was designed. Details of tasks performed by a monitored device are not important to an understanding of the present invention.

In step 303, a monitored device may receive three types of trigger events. The first type of trigger event is a data collection request from the primary device to provide status information. The second type of trigger event is a notification that the device reporting time has been reached, which is an abnormal event since the device reporting time should be restarted following each successful data collection cycle. The third type of trigger event is a device failure notification.

In step 304, the monitored device, assuming it isn't the primary device itself, decides whether to send status information to the primary device. As noted earlier, a monitored device may belong to more than one group and may have recently reported its status to another primary device. If the monitored device has recently provided status information to another primary device (or has passed its own information on to the monitoring server in acting as a primary device for a different group), it may elect in step 307 to ignore a trigger event asking for a new status report. In one embodiment, the monitored device may elect to ignore the trigger event if it determines that the time remaining until it expects to again provide status information to the other primary device (or to provide its own status to the monitoring server as an acting primary device) is less than a predetermined threshold time.

Assuming a monitored device does not elect to ignore a request for status information, it provides that status information to the primary device in step 305. In step 306, the monitored device establishes the next time at which the primary device is expected to provide group status information to the monitoring server.

If the type of trigger event received at a monitored device in step 303 is notification that a reporting time has been reached, the monitored device must decide in step 308 whether it has received that event as a primary device. If it is acting as a primary device, it begins performing the operations expected of a primary device in step 312. Those operations were described with reference to FIG. 2. If the monitored device is not a group primary device, it responds to the trigger by returning its status information to the requesting primary device in step 309. In step 310, the monitored device resets or initializes is reporting cycle counter to establish the next time at which it might have to provide an unsolicited status report. In step 311, the monitored device accepts any new group information originating with the monitoring.

If the type of trigger event received by the monitored device in step S303 is a device failure notification, the monitored device responds, in step 313, by immediately reporting the failure to the monitoring server.

Regardless which type of trigger event is received at a monitored device, once the processing resulting from that trigger event has been completed, the monitored device waits for the next trigger.

FIG. 4 illustrates an initialization process for a monitored device according to one embodiment of the present invention. Upon start of the initialization process, the monitored device acquires the expected reporting cycle and the address of the monitoring server in step 402. This step can be implemented through the use of a configuration file for the monitored device. The required configuration information in the configuration file may be stored in external storage or may be provided as data included in an application program in source or binary form. The address of the monitoring server must, of course, be in a form recognizable by the current network, for example, an IP address in an IP network, a URL address in an HTTP network, the MAC address of the monitoring server in a 802.15.4 sensor network, etc.

Preferably, as part of the initialization process, the monitored device receives grouping information in a step 403. One objective of the initialization process to divide monitored devices into initial groups which will hopefully provide some load balancing benefits for the monitoring server. In general, initial grouping can be implemented using a default grouping scheme, for example, dividing the monitored devices with similar IDs into a group, dividing physically proximate devices into a group, etc. The initial grouping can be specified in a configuration file, by user input or by the monitoring server. As noted earlier, a preferred implementation would initially group monitored devices having similar reporting cycles.

FIG. 5 illustrates part of a preferred initialization method for a new monitored device according to one embodiment of the present invention. In step 502, the new device makes a network-wide request for information about the reporting cycles of other devices already in the network with the goal of identifying an existing group of monitored devices having reporting cycles similar to its own. If one of the responses is from a group primary device, the joining device will give priority to the group including the primary device in making a join decision. If there is no reason for the joining device to favor one existing group over another, it may join an existing group at random. Different methodologies of deciding which group to joint will occur to those skilled in the art.

FIG. 5 includes detail about a preferred methodology. Once the joining device has received reporting cycle information from other existing devices in, it reads the reporting cycle for the primary device in one of the groups in step 503 and determines in step 504 whether the primary device reporting time is within a predetermined span from its own later reporting time. If the primary device has a reporting time that occurs before but acceptably close to the device's own reporting time, it responds in step 505 by asking the primary device for approval to join the group monitored by the primary device. If approval is granted by the primary device, the primary device confirms the join and sends any needed information to the joining device.

If it is determined in step 504 that there is no primary device which has an acceptable reporting time, the received broadcast information may be ignored and the joining device assigned to an existing group in step 506 using one of the other methodologies previously described.

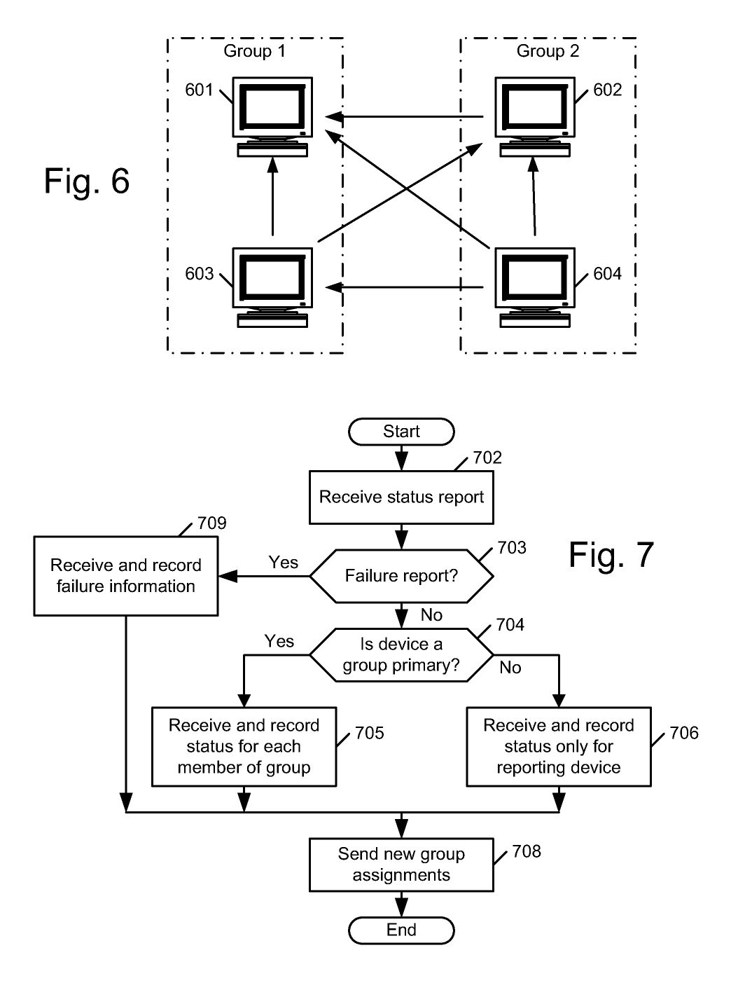

FIG. 6 illustrates the result of the preferred initialization method in a specific. Assume the first device 601 in a local network starts up at 8:00 and establishes that its next status report is due at the monitoring server at 9:00. Since it is the first device in the local network, there will be no other devices to receive its broadcast, which means it will receive no responses and have no group to join. When the second device 602 in the local network starts up at 8:01, its next time of reporting to the monitoring server may be set at 12:00. The second device 602 will broadcast its join request to device 601, the only other device currently in the network. However, when the first device 601 receives the broadcast, it will see that there is a large difference between its reporting time and reporting time of the second device 602. Consequently, the first device 601 will ignore the broadcast and no attempt will be made to place the two devices in a single group.

When a third device 603 starts up in the local network at 8:02 with a next reporting time of 9:00, it broadcast its presence to both of the devices 601 and 602. Because of the disparity with the next reporting time for device 602, the broadcast will be ignored by device 602. However, the device 601 can conclude that its reporting time is acceptably close to the reporting time for device 603 and respond to the join request broadcast by device 603. After interaction, devices 601 and 603 can be combined to form a single group G1. One of the two devices will be assigned the role as the group primary device.

When a fourth device 604 starts up in the local network at 8:03 with next reporting time of 12:00, it will broadcast its join request to all three existing devices 601, 602 and 603. Because of the large difference between the next report time of fourth device 604 and the next report time of the devices 601 and 603 in group G1, the broadcast join request will be ignored by both devices 601 and 603. However, device 602 will respond to the broadcast because its reporting time is similar to that of device 604. After interaction, devices 602 and 604 will be joined into group G2 with one of the two assuming the role of group primary device.

FIG. 7 illustrates operations performed by the monitoring server during a reporting cycle according to one embodiment of the present invention. Once the reporting cycle begins, the monitoring server waits for status reports from monitored devices. On receipt of a status report in step 702, the monitoring server determines in step 703 whether the status report is normal or a failure report. Assuming step 703 shows the status report is a normal report and not a failure report, the monitoring server determines in step 704 whether the report is from a group primary device or directly from a monitored device that belongs to an existing group. If the report is from a group primary device, in step 705 the monitoring server receives and records the reported information associating it either with the group primary device or the appropriate member device within the group. If the status report is from a device other than a group primary device, it is still received and recorded in step 706 but is associated only with the member device that provided the report.

In a next step 707, the monitoring server will generate grouping assignments for all devices covered by the received status report. As part of this process, the monitoring server may create new groups consisting of only some of the devices covered by the received status report. As noted earlier, in a preferred embodiment, devices may be grouped with other devices having similar reporting times. As part of the group set up process, the monitoring server will indicate when it next expects to receive a status report from each group. The group assignments are sent in step 708 to end the operations.

The monitoring server can save and maintain received status information using database technologies or other known technologies. or in other ways known by skilled in the art. Preferably, device information is kept in a database. The information can include the IDs of the monitored devices, reporting time, status information, and next reporting time, etc. Database searches may be used to identify monitored devices having similar reporting times, which are candidates for a single new group. In step 708, the monitoring server sends the new group information to the new primary device of the new group. If a monitored device has special requirements, for example, the monitored device, as the primary device, can only report the status information of less than 5 monitored devices, these requirements are taken into account in forming new groups. Special requirements can be maintained by the monitoring server, by the primary device of each group or by the member device itself. Status information reported to the monitoring server for a particular monitored device includes any special requirements for the devices.

If information is received in step 703 had been a failure report rather than a conventional status report, the monitoring server receives and records this failure information in step 709. The reporting cycle ends after reported information, whether a conventional status report or a failure report, is received and stored.

It should be noted that, if the report cycles for many clients are same, it is theoretically to overload the monitoring server at a given time. However, the real risk of an overload is considered low. The reasons are the following. Each monitored device reports to monitoring server immediately after initialization. As the initialization times of monitored devices are different, the reporting cycles for different monitored devices will end at different times.

Even if a large number of monitored devices did start up at substantially the same time, any overload of the monitoring server would likely be short-term. Once monitored devices are assigned to groups, the member devices will ordinarily leave the task of communicating with the monitoring server to the group primary device, greatly reducing traffic to the monitoring server. Even if the overload continues for the first few reporting cycles, the reassignment of member devices to different groups at the end of a reporting cycle can be used to balance the workload of the monitoring server.

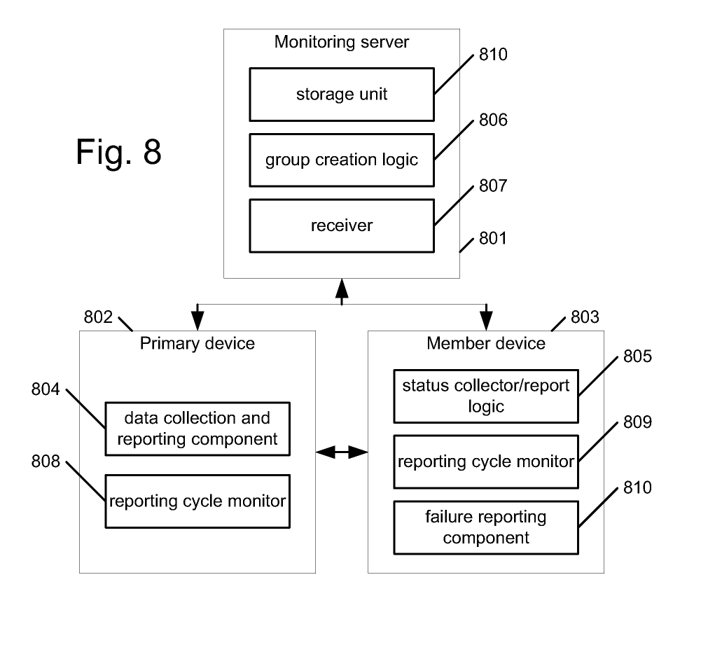

FIG. 8 illustrates a system for monitoring and managing distributed devices according to one embodiment of the present invention. Monitoring server 801 includes a receiver 807 for receiving status information and failure information sent by monitored devices, a storage unit 810 for storing the status information and failure information sent by monitored devices, and group creation logic for setting up groups at the conclusion of each reporting cycle. As noted earlier, the monitored devices are joined into groups with each group having a primary device that ordinarily reports status information to the monitoring server. To simplify the drawing, a single primary device 802 and a single member device 803 are shown.

The primary device 802 includes a data collection and reporting component 804 which can acquire status information from member devices assigned to its group and pass the aggregated device information (including its own) on to the monitoring server. Primary device 802 also includes a reporting cycle monitor for determining when to start collecting status information from group member devices and when to pass the aggregated information to the monitoring server. Primary device 802 ordinarily includes other components (not shown) for performing other functions unrelated to the monitoring function.

Each member device 803 includes a status collector/reporting component 805 that acquires and stores status information about the member device, a reporting cycle monitor 809 for monitoring reporting cycles and a special failure reporting component 810 that is activated only when a failure condition is detected at the member device.

During normal operation, the primary device 802 will poll or interrogate member device 803 and other member devices in the group for status information beginning at a predetermined time before the primary device is required to pass group status information to the monitoring server. Under exceptional conditions, member devices such as device 803 can report status information directly to the monitoring server. The exceptional conditions include, but are not necessarily limited to, a failure at the member device that needs to be reported immediately to the monitoring server and an expiration of the member device's own reporting cycle, which is an indication of a failure either of the primary device or of the network connecting the primary device and the member device.

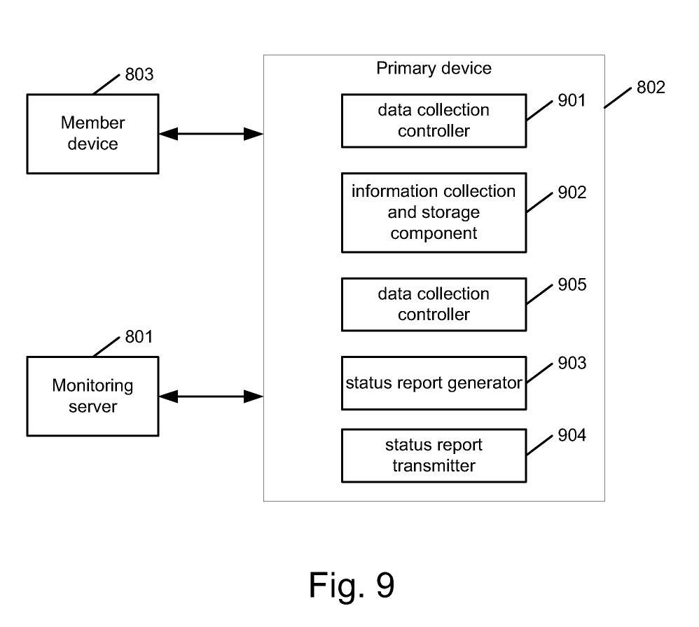

FIG. 9 illustrates a preferred functional structure for a group primary device. The primary device comprises a data collection controller 905 for deciding which of the group member devices to poll or interrogate for status information, a polling component 901 for contacting member devices during a data collection phase; an information collection/storage component 902 for receiving status information of member devices and storing it at least temporarily; a report generator 903 for organizing the group status report that is to be sent to the monitoring server and a report transmitter component 904 for handling the actual transfer of the status report to the monitoring server.

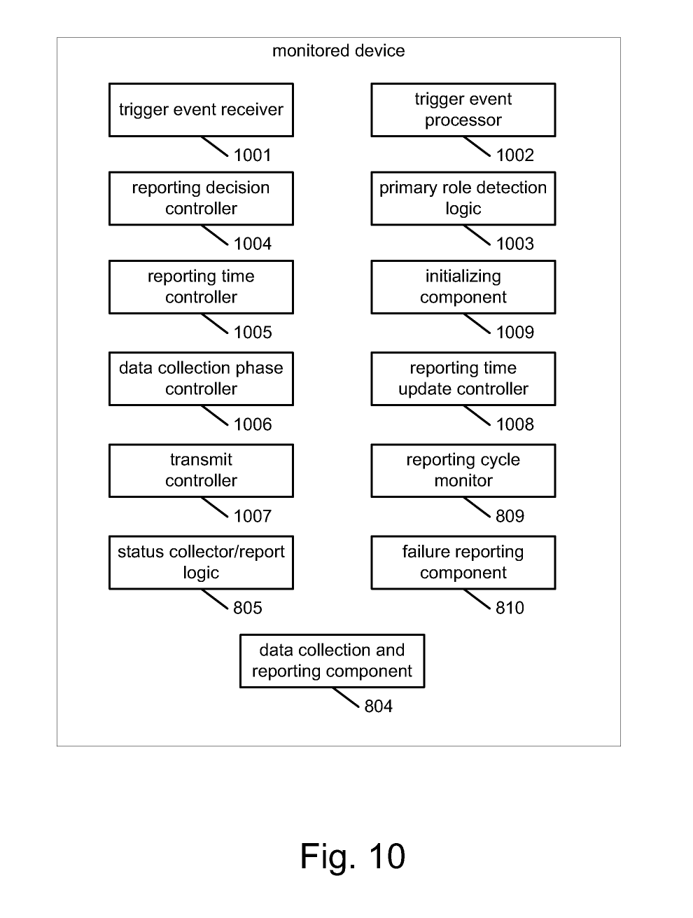

FIG. 10 illustrates the functional structure of a monitored device according to one embodiment of the present invention. Each monitored device must include all the components required for operation as either a primary device or a member device. That means every monitored device includes a reporting cycle monitor 809, a local status information collector component 805, a data collection/reporting component 804 and a failure reporting component 810. Additionally each monitored device must include a reporting decision controller 1004, a transmit controller 1007 for determining when and if to send information to a primary device, a trigger event receiver 1001, a trigger event processor 1002, a primary role detector 1003, a reporting time controller 1005, a reporting time update component 1008 and an initialization component 1009. The reporting decision controller 1004 requires information provided by the reporting time controller 1005, and the data collection phase controller 1006.

The present invention may also be embodied as a program product, which comprises the program code implementing the above methods when loaded into and executed by a computer and a recording medium for storing the program code.

Although the illustrative embodiments have been described herein with reference to the accompanying drawings, it is to be understood that the present invention is not limited to those precise embodiments, and that various other changes and modifications may be made therein by one of ordinary skill in the related art without departing from the scope or spirit of the invention. All such changes and modifications are intended to be included within the scope of the invention as described by the appended claims.

What is claimed is:

1. A method for monitoring and managing distributed devices, wherein a monitoring server is used to monitor a plurality of monitored devices that are divided into a plurality of groups, one of monitored devices in each group being a primary device for the group, and the others being the member devices of the group, the method comprising:
receiving group status information at the monitoring server from the group primary device;
selecting one or more of the monitored devices to create a new group in; and
sending information about the new group to the primary device of the new group.

2. A method according to claim 1 further including the step of receiving status information directly from a member of a group under predefined conditions.

3. A method according to claim 2 wherein the predefined conditions include a failure of the group primary device to collect status information from the member before a predetermined time.

4. A method according to claim 3 wherein the predetermined time is the end of a reporting cycle maintained by the reporting member.

5. A method according to claim 4 wherein the step of selecting one or more of the monitored devices to create a new group further comprises the step of selecting devices for the group as a function of the reporting time for those devices.

6. A method according to claim 5 wherein the primary device for the new group is the same device that was the primary device for the old group.

7. A method according to claim 4 wherein the step of sending information about the new group to the primary device of the new group comprises sending the identity of all members of the new group to the primary device and the time at which a group status report should be sent to the monitoring server by the primary device for the new group.

8. A server apparatus for monitoring and managing distributed devices assigned to a plurality of groups, one of monitored devices in each group being the primary device of the group, the apparatus further comprising:
a receiver component for receiving group status information from the primary device of the group; and
a group creation component assigning distributed devices covered by the group status report to one or more new groups, for assigning one member of each new group the role of primary device and sending group information to the newly assigned primary device for the group.

9. A server apparatus according to claim 8 wherein said receiver component receives information directly from one or more members of a group under predefined conditions.

10. A server apparatus according to claim 9 wherein the predefined conditions include a failure of the group primary device to begin collecting status information from the member by a predetermined time.

11. A server apparatus according to claim 9 wherein the predetermined time is the end of a reporting cycle maintained by the member.

12. A server apparatus according to claim 11 wherein the group creation component selects members for a new group as a function of the reporting times for those devices.

13. A server apparatus according to claim 12 wherein the primary device for the new group is the same device that was the primary device for the old group.

14. A computer program product comprising a computer usable media embodying program instructions, said program instructions when loaded into and executed by a computer enabling the computer to monitor and manage distributed devices, arranged in groups with each group having a primary device, by:
receiving group status information at the monitoring server from the group primary device;
selecting one or more of the monitored devices to create a new group in; and
sending information about the new group to the primary device of the new group.

15. A computer program product according to claim 14 including additional program instructions for enabling the monitoring server to receive status information directly from a member of a group under predefined conditions.

16. A computer program product according to claim 15 wherein the predefined conditions include a failure of the group primary device to collect status information from the member before a predetermined time.

17. A computer program product according to claim 16 wherein the predefined conditions include a failure of the group primary device to collect status information from the member before a predetermined time.

18. A computer program product according to claim 17 wherein the predetermined time is the end of a reporting cycle maintained by the reporting member.

19. A computer program product according to claim 18 wherein program instructions for sending information about the new group to the primary device of the new group comprises program instructions for sending the identity of all members of the new group to the primary device and the time at which a group status report should be sent to the monitoring server by the primary device for the new group.
